(19) United States
(12) Patent Application Publication
(10) Pub. No.: US 2006/0291656 A1
(43) Pub. Date: Dec. 28, 2006

(54) Encryption method and decoding method for a digital transmission system

(75) Inventors: Francesc Dalmases, Aachen (DE); Joachim Kahlert, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/567,840

(22) PCT Filed: Aug. 3, 2004
(86) PCT No.: PCT/IB04/51378

§ 371 Date: Feb. 8, 2006

(30) Foreign Application Priority Data
Aug. 13, 2003 (EP) 03102524.0

(51) Int. Cl. H04L 9/28; H04L 9/00; H04K 1/00

(52) U.S. Cl. 380/268; 380/28

(57) ABSTRACT

An encryption method and decoding method for a digital transmission system, in which the digital data stream comprises an alternating sequence of training sequences and data symbols, and the training sequences are dynamically coded. At the receiving end, a decoding code (Vn) is generated by a code generator as a function of an encryption key (200). This decoding code is sent to a correlator, where it is mixed with the encryption code Vn extracted from the digital data stream. The correlator generates a correcting variable to compensate the offset in respect of time or frequency between the sender and receiver. Encryption is achieved through the alteration of the code used during the transmission.

The invention relates to both an encryption method and a decoding method for a digital transmission system comprising a sender and a receiver, wherein the transmission may be either wireless or wired as desired. In a digital communications system, the receivers have to be synchronized with the symbols that arrive in modulated form, in order to achieve the optimum demodulation. Frequency synchronization is important for multi-carrier modulation systems, and in particular for the OFMD (Orthogonal Frequency Division Multiplex) multi-carrier method. Errors in timing or discrepancies in the frequency (frequency offsets) introduce Inter-Carrier Interference (ICI) and Inter-Symbol Interference (ISI) to the transmission system, so that demodulation of the symbol is no longer possible.

A known synchronization method is that of Data Aided Synchronization. The principle of this synchronization method is the use of training sequences or pilot subcarriers with reference symbols, which are stored in both the sender and the receiver. Firstly, the training sequence is extracted from the scanned incoming signal and sent to a correlator, and secondly, the reference sequence stored in the receiver is invoked and also sent to the correlator. On the basis of the maximum found by the correlator, the scanner is controlled, during the time-rasterized interrogation of the incoming signal, to the effect that the sender and receiver are as synchronous as possible. The correlation of the received training sequence with the stored reference sequence enables an estimation of the symbol timing and frequency offset.

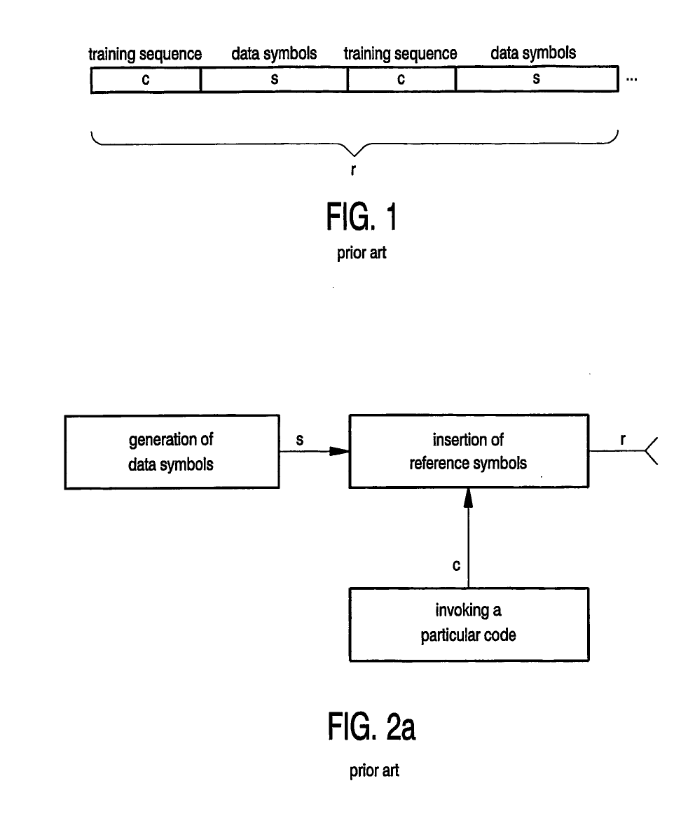

FIG. 1, illustrating the prior art, shows, schematically, a digital data stream r, which comprises an alternating sequence of reference symbols from a training sequence c and data symbols s. The training sequence c exhibits reference symbols, which are stored in both the sender and the receiver, and may be, for example, a sequence of successive bits of constant length. Codes generated by random generators are normally used for the training sequence.

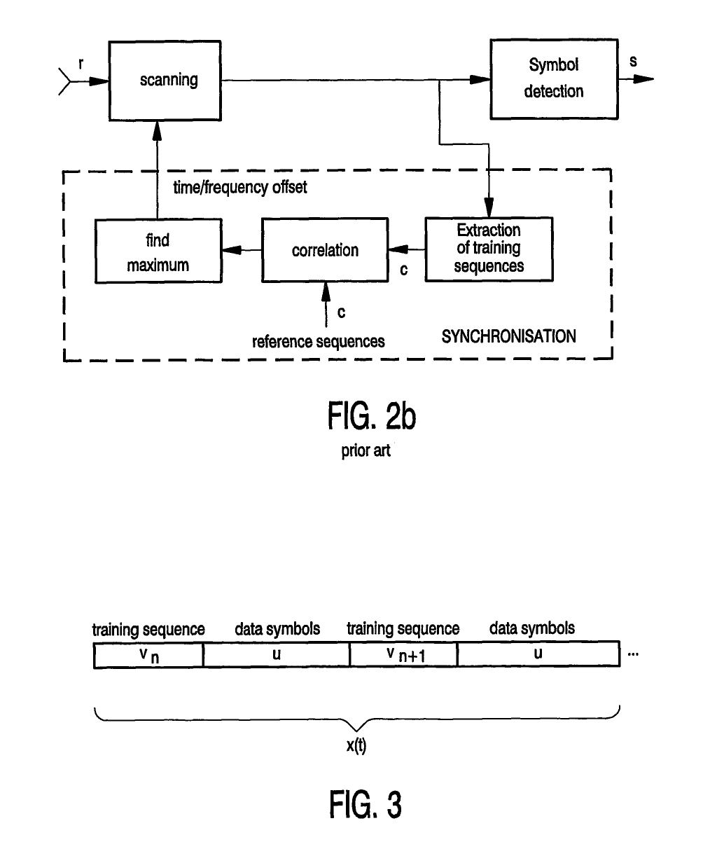

The basic method for synchronization is shown in FIGS. 2a) and 2b), illustrating the prior art. FIG. 2a) shows the insertion of the data symbols s with the constant code c. The digital data stream r to be transmitted derives from this.

In FIG. 2b), the training sequence is extracted from the received data stream r with the vector c. It is compared with the reference sequence c stored or generated in the receiver. When a maximum is found, the control of the symbol clock and the timing of the receiver's symbol are matched to those of the sender, and the frequency offset is thereby compensated as far as possible. The reference sequence, or training sequence c, comprises a vector with a number P of reference symbols. The vector is hereby described by the following equation (1):
c=[c₀c₁Cc_{(P-1)}]^{T} (1)

This method can be used in both the time domain for the symbol timing and the frequency domain for the frequency estimation. It is described here as a typical example of systems that use data-supported synchronization.

The vector c remains constant for the duration of the connection. This enables an unauthorized third party to synchronize a device relative to the existing connection, e.g. by testing out different codes. An unauthorized third party could thus intercept the connection using suitable means.

It is therefore an object of the invention to specify for a digital transmission system of the same generic type an encryption method that increases the security from interception of the data stream. It is further an object of the invention to specify a method for decoding a digital data stream that has been transmitted in encrypted form. It is also an object of the invention to specify an appliance for implementing a method of this kind. It is furthermore an object of the invention to specify a digital transmission system with increased security from interception.

As regards the encryption method for a digital transmission system, the object is achieved by a method in which the digital data stream comprises an alternating sequence of training sequences or pilot carriers (below merely designated training sequences) and data symbols, and the training sequence is transmitted in coded form in such a way that the coding of the training sequence takes place with a dynamic encryption code. In this connection, dynamic means that the training sequence, which is formed by a vector of a specific length, has a differing content over the course of time. This means that, during a transmission, the content of the training sequence changes, as a result of which the security from interception is increased and one encryption level is reached.

In accordance with one embodiment of the invention, the dynamic encryption code is generated by a random generator.

Another embodiment of the invention uses for the encryption method individual elements in succession from a defined set of encryption codes. This defined set of encryption codes may, for example, have been generated in advance by the random generator, or may have been programmed when the corresponding appliance was produced.

In accordance with another embodiment of the invention, the dynamic training sequences are individual elements from a set of training sequences, and are applied successively. This set of training sequences may hereby either:

be transmitted from the sender to the receiver and put into (intermediate) storage by the latter or

be generated by the receiver in accordance with a defined pattern, with this taking place either in advance with subsequent intermediate storage or just in time.

In accordance with another embodiment, the set of dynamic training sequences is implemented in the form of a loop, from the beginning to the end and then starting at the beginning again. This ensures that each individual training sequence is used only for a specific time and, in the case of data transmissions taking longer than this, a semi-static state of the coding is not reached as a result of the last element of the training sequence having been used continuously. With these embodiments, the training sequences are changed simultaneously at the transmitting end and the receiving end. The moments at which the training sequences are changed are known to the sender and receiver, having been agreed between the sender and receiver during the connection setup.

As regards the decoding method, the object is achieved by a method for a digital data stream established by a scanner and comprising an alternating sequence of training sequences and data symbols, wherein the training sequences are coded and, following scanning of the received digital data stream, extracted from it and sent to a correlator, wherein a receiving-end decoding code is also sent to the correlator, which, on the basis of the two signals, finds a maximum, which is used as the correcting variable for the time and frequency correction of the scanner, and wherein the decoding code is dynamic and a code generator generates the dynamic decoding code as a function of an encryption key. Since the decoding code changes over time, i.e. it is dynamic, the security from interception is increased. The code generator generates the dynamic decoding code as a function of the content of an encryption key, which was transmitted at the start of the data transmission and which contains information that is necessary for the generation of the dynamic code. The result of the correlation represents a measure of the time and frequency offset between the sender and receiver.

In accordance with one embodiment of the invention, a permutation function defines the content of a set of decoding codes. A set contains multiple decoding codes, which are compiled by a permutation function on a quasi-random basis, wherein the permutation function uses a specified quantity (a pool) of decoding codes. Since the individual decoding codes in the pool can be compiled in a different order again and again, there is a relatively great number of possible compiled sets of decoding codes for a relatively small memory space requirement.

In accordance with a further embodiment of the invention, the decoding method comprises the following steps:

transmitting of an encryption key and thereby:
defining a permutation function
defining a set of decoding codes
defining a hop interval,

wherein the last three steps may be performed in any order. The permutation function defines the order in which specific decoding codes are extracted from a pool and stored in a set of decoding codes. The hop interval indicates the number of data packets, or the time duration, after which the change to the next decoding code takes place.

In accordance with a variant of the invention, a permutation procedure is implemented, comprising a loop with the following steps:

set an interval to 1;

wait for the end of a predefined hop interval;

increase the interval by the value of 1;

undertake a comparison of whether the current value of the interval is greater than the total number of elements in a permutation function, which indicates the positions of the dynamic codes to be used for a decoding of the digital data stream,

wherein, either the following takes place if the result of the comparison is positive:

reset the interval to a value of 1;

or, if the result of the comparison is negative:

equate the current decoding function with the decoding code corresponding to the code for the position specified by the permutation function.

This permutation function provides for an individual decoding code to be used for the time duration of an interval and then replaced by a different decoding code.

To summarize, the security from interception is increased by the changing of the code over time, wherein different encryption levels are achieved depending on the variant of the invention. The following measures:

1) The use of a set of different encryption codes

2) The use of a permutation function and/or

3) The use of a hop interval, which differs in length for different connections,

may hereby be utilized individually or in conjunction with one another. The more measures are realized, the higher the complexity and thus the encryption level. The complexity is further increased through the use of factors of greater content and thereby greater variety.

The invention is utilized in the physical layer of the OSI 7-layer model.

As regards the appliance, the object is achieved by an appliance for the synchronization of a receiver with a received digital data stream, wherein, for the implementation of the synchronization, training sequences are extracted from the received data stream and sent to a correlator, where they are mixed with a decoding code, the reference code, in order to find a maximum, which is used as the correcting variable for a scanner, and wherein the synchronization appliance is equipped with a dynamic code generator. The dynamic code generator alternatively generates the decoding code currently required or generates a complete set of decoding codes and stores them in a memory.

Within an appliance, e.g. a mobile phone, the dynamic generator may be used for encryption during transmission and for decoding during reception.

In accordance with one embodiment of the invention, the synchronization appliance is equipped with means for storing the encryption key, e.g. a RAM (Random Access Memory).

As regards the transmission system, the object of the invention is achieved by a digital transmission system, with an appliance for the synchronization of a receiver with a received digital data stream, in which the receiver is equipped with:

means for extracting training sequences;

means for determining a correcting variable for a scanner;

means for generating a dynamic code.

The correcting variable for the scanner is determined by, for example, a correlator. It influences the scanner to the effect that the timing or frequency offset between the sender and receiver is reduced. The means for generating a dynamic code may be, for example, a code generator, which generates the multiple decoding codes to be used for each connection in accordance with an encryption key.

A use of an encryption method and/or a decoding method, in which the digital data stream comprises an alternating sequence of training sequences and data symbols and the training sequences are dynamically coded, in wired or wireless networks, such as a telecommunications network or a wireless LAN (Local Area Network).

The invention will be further described with reference to examples of embodiments shown in the drawings, to which, however, the invention is not restricted.

FIG. 3 shows, schematically, a digital data stream with dynamically altered training sequences.

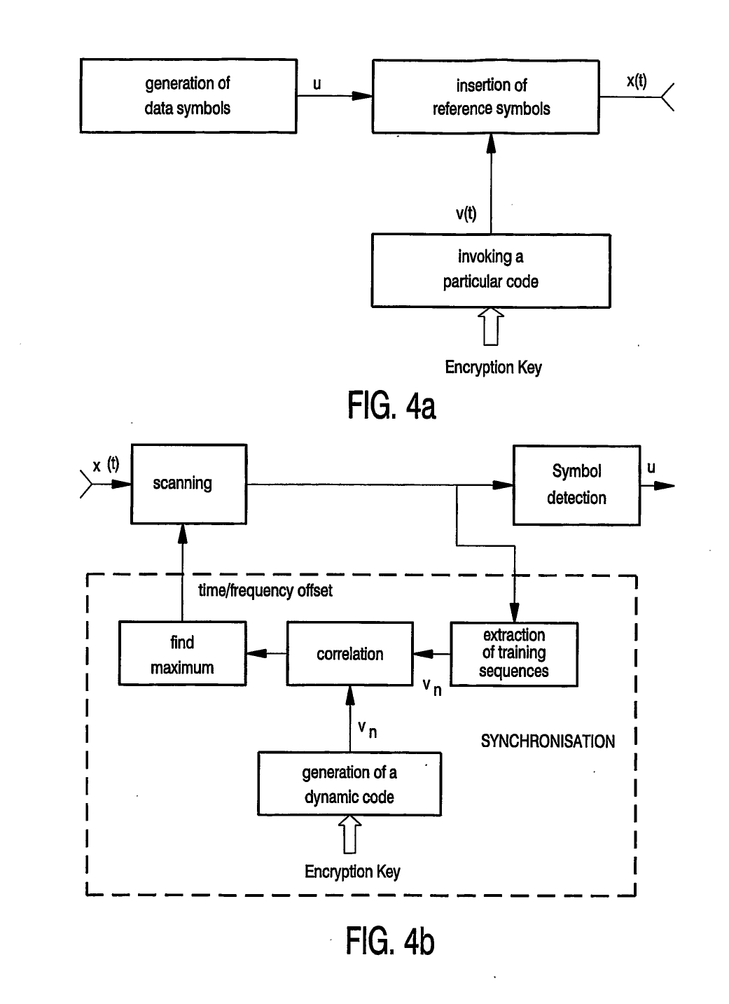

FIG. 4 shows, schematically, in two parts a) and b), a flowchart for the synchronization of a receiver with a received dynamically encrypted data stream.

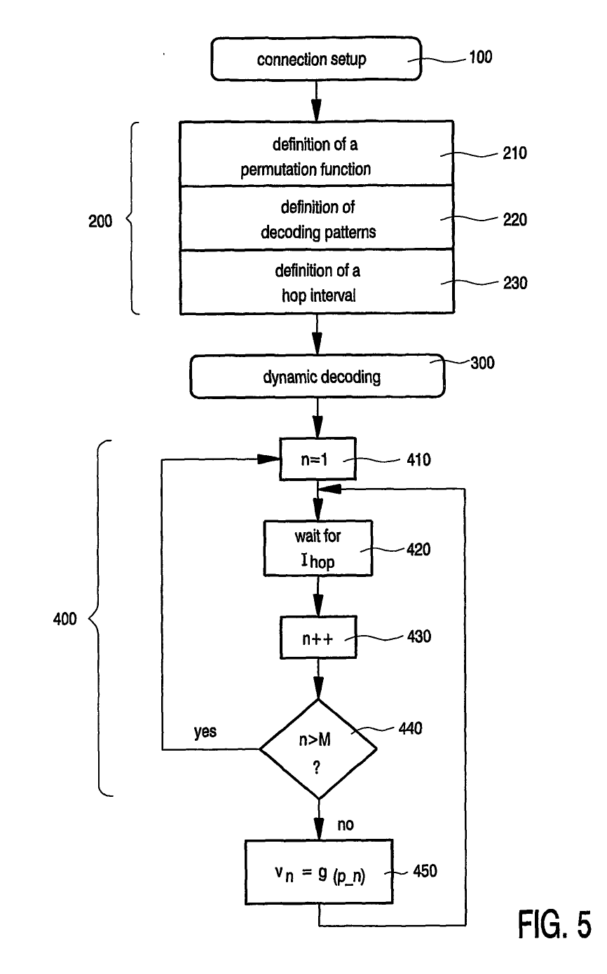

FIG. 5 shows a flowchart of a decoding method.

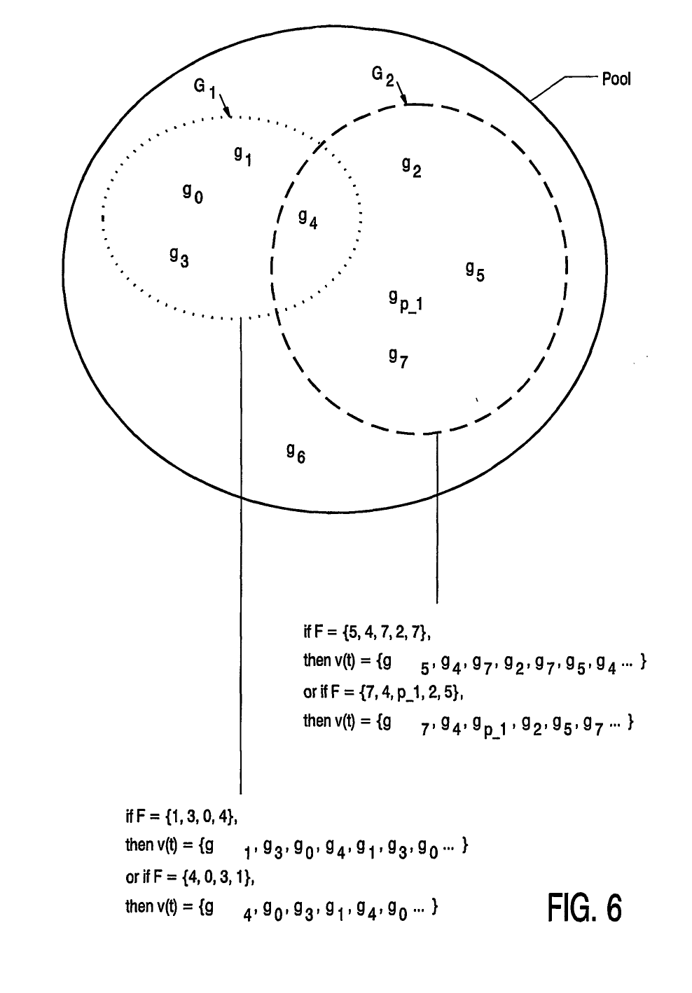

FIG. 6 shows a pool of individual codes.

FIG. 3 shows, schematically, a digital data stream x(t), which comprises an alternating sequence of dynamically altered training sequences vₙ, vₙ₊₁ and data symbols u. A training sequence vₙ or vₙ₊₁ is transmitted in coded form. Because the code is changed in the course of the transmission, a first encryption level is achieved. In this connection, coding means that one and the same code is used for the duration of the transmission. Encryption in this connection means that at least two different codes are used for the duration of the transmission.

With this embodiment example, with a hop interval that is shorter than the duration of the data symbols, a different code is used for at least two successive training sequences, indicated by vₙ and vₙ₊₁. Both codes vₙ, vₙ₊₁ comprise the same number P of reference symbols used for the synchronization. Each code vₙ, . . . vₙ₊₁ exhibits the same number P of reference symbols, but the reference symbols themselves differ. Other variants change the code after a higher number of data symbols or after the expiry of a predetermined time.

FIG. 4a) shows the mixing of the data symbols u generated in the sender with the encryption code v(t), changed over time. The result is the digital data stream x(t).

FIG. 4b) shows a flowchart for the synchronization of the receiver with the received data stream x(t). The scanning of the received data stream x(t) is time-dependent. In order to achieve an optimum result, it is important for the timing or frequency offset between the sender's local clock and the receiver's local clock to be small. Following extraction of a training sequence vₙ, it is sent to a correlator, where it is compared with the receiver's reference signal vₙ. The result of the correlation is examined for a maximum, which is used as the correcting variable for adjusting the scanner. The synchronization method described here may be described as dynamic, since the code for encryption of the training sequences changes over time. A dynamic code generator generates the receiving-end comparative training sequence vₙ, i.e. the reference signal, in accordance with an encryption key. The variable (t) makes clear that the encryption code v(t) changes over time, i.e. is dynamic. The subscript index n stands for a particular momentary encryption code vₙ, which is replaced by the next momentary encryption code vₙ₊₁.

FIG. 5 represents, schematically, in a flowchart, a method in accordance with the invention for synchronizing a receiver of a digital transmission system with the received digital data stream x(t). Following the connection setup at 100, the encryption key is transmitted at step 200, initiating the defining, in any order, of the following parameters:

a permutation function Fᵢ 210;

a set of decoding patterns Gᵢ 220;

a hop interval Iₕₒₚ 230.

The encryption key 200 is generated by the transmitting unit and contains the parameters required for the decoding of the transmitting data signal and for the synchronization.

The permutation function Fᵢ={p_{—}1, p_{—}2 . . . p_M} indicates the order in which the individual codes g₁, g₂ . . . g_{H} from a set of Gᵢ encryption patterns are used, wherein p_{—}1, p_{—}2 . . . p_M are arbitrary integers 1, 2 . . . H. If, for example, a specific permutation function is F={2, H}, this means that p_{—}1=2 and p_{—}2=H, and, during decoding, the encryption code g₂ is used first, followed by the encryption code g_{H}. If the connection is then not yet completed, the decoding is continued in the form of a loop, with p_{—}1, i.e. g₂, and then with p_{—}2, i.e. g_{H}. The defining at 210 of the permutation function valid for the current transmission may take place by means of either one of the following:

a) Transmission of a vector Fᵢ, which contains the specific permutation sequence {p_{—}1, p_{—}2 . . . p_M} or

b) Transmission of only the name of an individual permutation function Fᵢ.

Alternative a) enables an unauthorized third party to intercept the permutation sequence and therefore comprises an aid to decoding the training sequence of the transmitted digital data stream. However, this method has the advantage that space is memory saved, both at the transmitting and the receiving end, since the permutation sequence valid for the current transmission need only be put into intermediate storage and may be deleted on termination of the transmission.

Alternative b) presupposes that, both at the transmitting and the receiving end, all possible permutation functions F₁, F₂ . . . F_{L} (L: integral) have to be permanently stored in order that the permutation function Fᵢ valid for the transmission can be invoked. The advantage of this variant is that an unauthorized third party cannot determine the sequence of codes Gᵢ implied by the permutation function Fᵢ used, since it is not transmitted.

A set Gᵢ of decoding patterns contains H orthogonal codes g₁, g₂ . . . g_{H}, which are capable of altering the training sequence. Each individual one of the H orthogonal codes v is hereby constructed as a vector with P elements. The constants H and P are integers. The step of defining a set Gᵢ of encryption codes at 220 may take place by means of either one of the following:

c) Transmission of the specific, individual orthogonal codes g₁, g₂ . . . in the form of vectors, or

d) Transmission of the names of the orthogonal codes to be used.

The advantages and disadvantages of alternatives c) and d) are, as with the alternatives a) and b), the defining of the permutation function Fᵢ, that the transmission of the specific information reduces the protection against interception, and the storing and invoking of predefined codes occupies memory space at both the transmitting and receiving ends.

Step 230, the defining of the hop interval Iₕₒₚ, means either:

e) Specifying a cycle duration Iₕₒₚ, i.e. a validity duration over time, e.g. 5 msec, or

f) Specifying a number Q of data packets, e.g. 3× the number of data symbols u.

Following the transmission of the encryption key, the dynamic decoding begins at 300. The first permutation procedure 400 is as follows. At step 410, the interval n is set to “1” and the code from set Gᵢ located at point p_{—}1 of the permutation function Fᵢ is used. At step 420, there is a wait for the expiry of the hop interval Iₕₒₚ. Measurement of the time for determining the end of the cycle duration, or the counting of the transmitted data packets, takes place by means of appropriate appliances, such as a counter or a flip-flop. When the end of the hop interval Iₕₒₚ has been reached, the interval n is increased by a value of 1 at step 430. At step 440, a comparison is made of whether the current value for the interval n is greater than the total number M of elements of the permutation vector. If the result of the comparison is “yes”, the loop starts again at step 410 and the interval n is reset to the value of “1”. If the result of the comparison is “no”, step 450 invokes the momentary decoding code vₙ located at the n-th position p_n of the permutation function Fᵢ, i.e. vₙ=g₍ₚ_{_{—}}ₙ₎, and this is applied continuously until the end of the hop interval Iₕₒₚ is reached in the course of the loop at step 420, after which the interval n is increased by a value of “1” at step 430.

FIG. 6 shows a pool of p_{—}1 encryption codes. A first subset, drawn with a dotted line, comprises 4 elements, which are combined, by way of example, to form two possible sets Gᵢ. In total, 24 options exist if it is assumed that each element occurs precisely once. A second subset, drawn with a broken line, comprises 5 elements. Again, two options are shown for encryption codes, with the variant that individual codes may occur multiple times.

1. An encryption method for a digital transmission system, in which the digital data stream (x(t)) comprises an alternating sequence of training sequences or pilot carriers and data symbols (u), and the training sequence is transmitted in coded form, characterized in that the coding of the training sequence takes place with a dynamic encryption code (vₙ).

2. An encryption method as claimed in claim 1, characterized in that the dynamic encryption code (vₙ) is generated by a random generator.

3. An encryption method as claimed in claim 1, characterized in that the encryption method uses individual elements (vₙ, vₙ₊₁. . . ) in succession from a defined set (Gᵢ) of encryption codes.

4. A method as claimed in claim 3, characterized in that the set (Gᵢ) of dynamic training sequences (g₁, g₂) is implemented in the form of a loop, from the beginning to the end and then starting at the beginning again.

5. A decoding method for a digital data stream (x(t)), which is established by a scanner and comprises an alternating sequence of training sequences and data symbols (u), wherein the training sequences or pilot carriers are coded and, following scanning of the received digital data stream (x(t)), extracted from it and sent to a correlator, wherein a receiving-end decoding code (vₙ) is also sent to the correlator, which, on the basis of the two signals, finds a maximum, which is used as the correcting variable for the time and frequency correction of the scanner, characterized in that the decoding code (vₙ) is dynamic and a code generator generates the dynamic decoding code (vₙ) as a function of an encryption key (200).

6. A decoding method as claimed in claim 5, characterized in that a permutation function (Fᵢ) defines the content of a set of decoding codes (vₙ).

7. A decoding method as claimed in claim 5, characterized by the following steps:
transmitting of an encryption key (200) and thereby:
defining (210) a permutation function (Fᵢ)
defining (220) a set of decoding codes (g₁, g₂, . . . g_{H})
defining (230) a hop interval (Iₕₒₚ),
wherein the last three steps (210, 220, 230) may be performed in any order.

8. A decoding method as claimed in claim 5, characterized by the implementation of a permutation procedure (400), comprising a loop with the following steps:
set (410) an interval (n) to 1;
wait (420) for the end of a predefined hop interval (Iₕₒₚ);
increase (430) the interval (n) by the value of 1;
undertake a comparison (440) of whether the current value of the interval (n) is greater than the total number (M) of elements in a permutation function (Fᵢ), which indicates the positions of the dynamic codes (gₙ) to be used for a decoding of the digital data stream (x(t)),
wherein, either the following takes place if the result of the comparison is positive:
reset the interval (n) to a value of 1;
or, if the result of the comparison is negative:
equate the current decoding function (vₙ) with the decoding code (gₚ_{_{—}}ₙ) located at the position (p_n) specified by the permutation function (Fᵢ).

9. An appliance for the synchronization of a receiver with a received digital data stream, wherein, for the implementation of the synchronization, training sequences or pilot carriers (vₙ) are extracted from the received data stream and correlated with the decoding code, characterized in that the synchronization appliance is equipped with a dynamic code generator.

10. A synchronization appliance as claimed in claim 9, characterized in that it is equipped with means for storing an encryption key (200).

11. A digital transmission system with an appliance for the synchronization of a receiver with a received digital data stream, characterized in that the receiver is equipped with:
means for extracting training sequences;
means for determining a correcting variable for a scanner;
means for generating a dynamic code.

12. A use of an encryption method and/or a decoding method, in which the digital data stream comprises an alternating sequence of training sequences or pilot carriers and data symbols, and the training sequence or the pilot carrier is dynamically coded, in wired or wireless networks.
